(19) United States
(12) Patent Application Publication
(10) Pub. No.: US 2026/0180293 A1
(43) Pub. Date: Jun. 25, 2026

(54) Cable Laying Device

(71) Applicant: Samuel Smith, Canton, IL (US)

(72) Inventor: Samuel Smith, Canton, IL (US)

(21) Appl. No.: 18/987,774

(22) Filed: Dec. 19, 2024

(51) Int. Cl. H02G 1/06; E02F 5/10; H02G 9/04

(52) U.S. Cl. CPC H02G 1/06; E02F 5/10; H02G 9/04

(57) ABSTRACT

A cable laying device for laying trench cable using an excavating vehicle includes a bracket. A pair of apertures extend through the bracket. A rod is positioned to extend through the pair of apertures. A coupler is coupled to the bracket wherein the coupler is configured to releasably attach the bracket to a boom arm of an excavating vehicle. A spool is rotatably positioned on the rod. The spool unwinds a cable onto a surface while the spool is rotated on the rod to position the cable along the surface while the excavating vehicle is moved adjacent to the surface.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to pay-off machines and more particularly pertains to a new pay-off machine for laying trench cable using an excavating vehicle.

### (2) Description of Related Art Including Information Disclosed Under 37 CFR 1.97 and 1.98

The prior art relates to pay-off machines. Generally speaking, Pay-off machines are used to unwind cable or coil from a spool. Typically, pay-off machines use controlled tension to control the speed at which the cable is unwound and to prevent the cable from becoming tangled as it is unwound. One common project is to unwind electrical cable from a spool to position the electrical cable in a trench, such that the electrical cable can be buried. Such projects often occur when building solar farms and other electrical generation plants. Traditionally, cable pay-off machines need to be placed within the trench and pulled or otherwise moved through the trench as the cable is unwound. Because both the cable and the pay-off machines are heavy, this can require a significant amount of labor and time, and can also risk injury, increasing the expense of the project. These pay-off machines also utilize numerous moving parts and other mechanical pieces, making them prone to failure and requiring additional time and labor for maintenance and repair. Thus, there is a need in the art for a more simplified wire pay-off device that can be used to lay cable from outside the trench.

### (h) BRIEF SUMMARY OF THE INVENTION

An embodiment of the disclosure meets the needs presented above by generally comprising a bracket. A pair of apertures extend through the bracket. A rod is positioned to extend through the pair of apertures. A coupler is coupled to the bracket wherein the coupler is configured to releasably attach the bracket to a boom arm of an excavating vehicle. A spool is rotatably positioned on the rod wherein the spool is configured to unwind a cable onto a surface while the spool is rotated on the rod and wherein the spool is configured position the cable along the surface while the excavating vehicle is moved adjacent to the surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a cable laying device according to an embodiment of the disclosure.

FIG. 2 is a front view of an embodiment of the disclosure.

FIG. 3 is a top view of an embodiment of the disclosure.

FIG. 4 is a side view of an embodiment of the disclosure.

FIG. 5 is an in-use view of an embodiment of the disclosure.

FIG. 6 is an in-use view of an embodiment of the disclosure.

FIG. 7 is an in-use view of an embodiment of the disclosure.

FIG. 8 is a detail view of an embodiment of the disclosure.

FIG. 9 is a perspective view of an embodiment of the disclosure.

### (j) DETAILED DESCRIPTION OF THE INVENTION

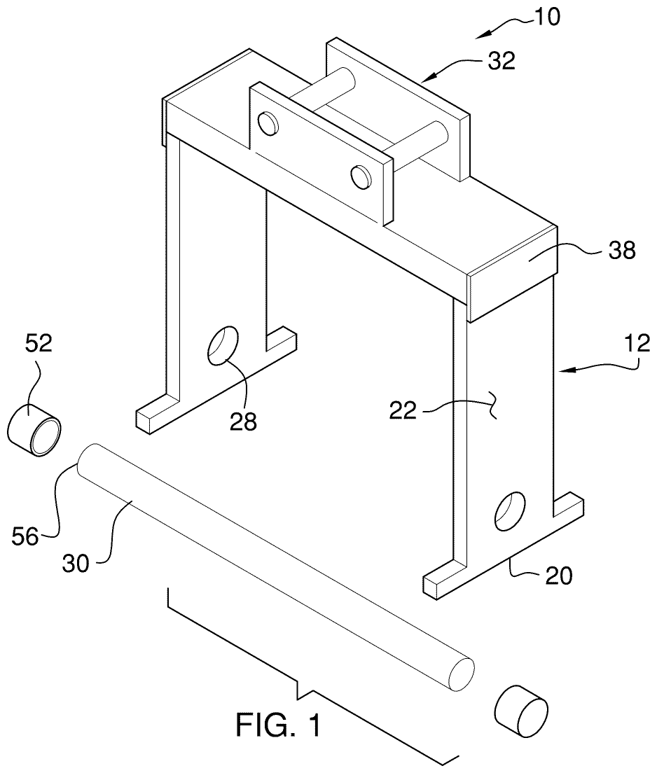

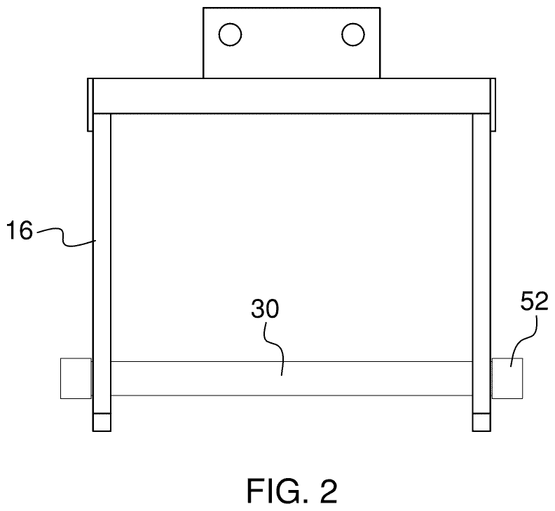

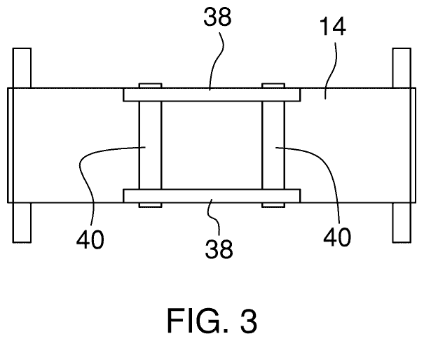

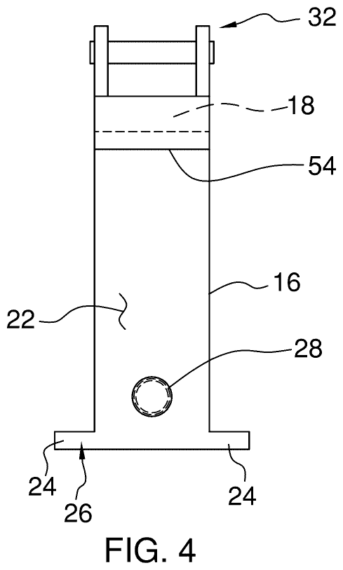

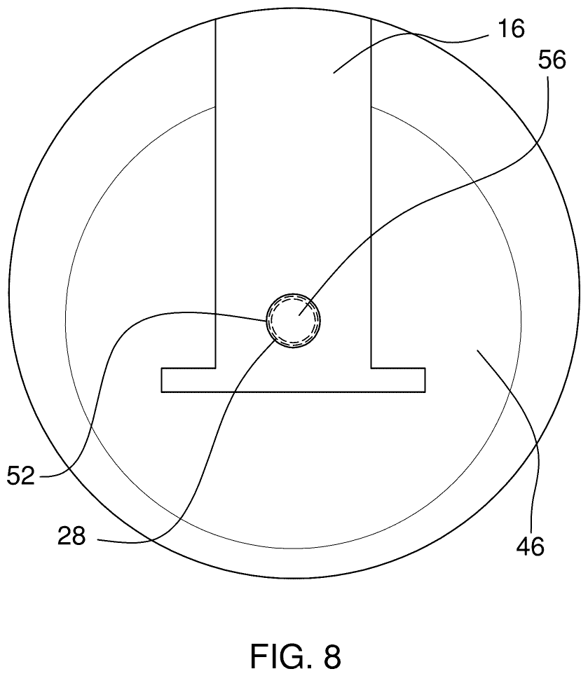

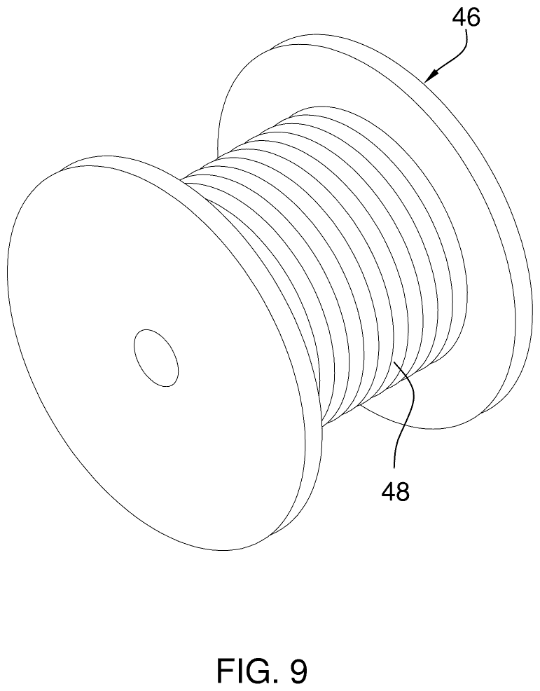

With reference now to the drawings, and in particular to FIGS. 1 through 9 thereof, a new pay-off machine embodying the principles and concepts of an embodiment of the disclosure and generally designated by the reference numeral 10 will be described.

As best illustrated in FIGS. 1 through 9, the cable laying device 10 generally comprises a bracket 12. The bracket 12 generally includes an upper wall 14 and a pair of lateral walls 16 that are coupled to and extend from the upper wall 14. For example, each lateral wall of the pair of lateral walls 16 may extend downwardly from a respective end surface of a pair of end surfaces 18 of the upper wall 14. Each lateral wall of the pair of lateral walls 16 may be perpendicular to the upper wall 14. Each lateral wall of the pair of lateral walls 16 generally has a terminal end 20 that is distally positioned on each lateral wall of the pair of lateral walls 16 relative to the upper wall 14. Each lateral wall of the pair of lateral walls 16 may have an outer surface 22 that is coplanar with the respective end surface of the pair of end surfaces 18 of the upper wall 14.

A plurality of flanges 24 may be coupled to the bracket 12. More specifically, a respective pair of flanges of the plurality of flanges 24 may extend from each lateral wall of the pair of lateral walls 16. The respective pair of flanges of the plurality of flanges 24 are generally positioned to extend outwardly from the terminal end 20 of each lateral wall of the pair of lateral walls 16. As shown in FIG. 1, the respective pair of flanges of the plurality of flanges 24 may extend outwardly in opposing directions from the terminal end 20 of each lateral wall of the pair of lateral walls 16, such that the respective pair of flanges of the plurality of flanges 24 extend away from each other. The respective pair of flanges of the plurality of flanges 24 may be perpendicular to the terminal end 20 of each lateral wall of the pair of lateral walls 16. Each flange of the plurality of flanges 24 may have an exterior surface 26 that is coplanar with the outer surface 22 of the lateral wall of the pair of lateral walls 16 on which each flange is positioned.

A pair of apertures 28 extend through the bracket 12. Each aperture of the pair of apertures 28 is generally positioned on a respective lateral wall of the pair of lateral walls 16. For example, each aperture of the pair of apertures 28 may be positioned proximate to the terminal end 20 of the respective lateral wall of the pair of lateral walls 16. The pair of apertures 28 are generally aligned with each other. Each aperture of the pair of apertures 28 may be centered between the respective pair of flanges of the plurality of flanges 24 extending from each lateral wall of the pair of lateral walls 16. Each aperture of the pair of apertures 28 may be vertically offset from the respective pair of flanges of the plurality of flanges 24 extending from each lateral wall of the pair of lateral walls 16.

A rod 30 is positioned to extend through the pair of apertures 28. In some embodiments, the rod 30 may be removably positionable to extend through the pair of apertures 28. The rod 30 is generally parallel to the upper wall 14 of the bracket 12 while the rod 30 is positioned within the pair of apertures 28. The rod 30 may have a length that exceeds a length of the upper wall 14 wherein the rod 30 extends outwardly past each lateral wall of the pair of lateral walls 16 while the rod 30 is positioned within the pair of apertures 28. The rod 30 may have a diameter that is complementary to a diameter of each aperture of the pair of apertures 28 wherein friction between the rod 30 and the pair of lateral walls 16 inhibits the rod 30 from rotating within the pair of apertures 28.

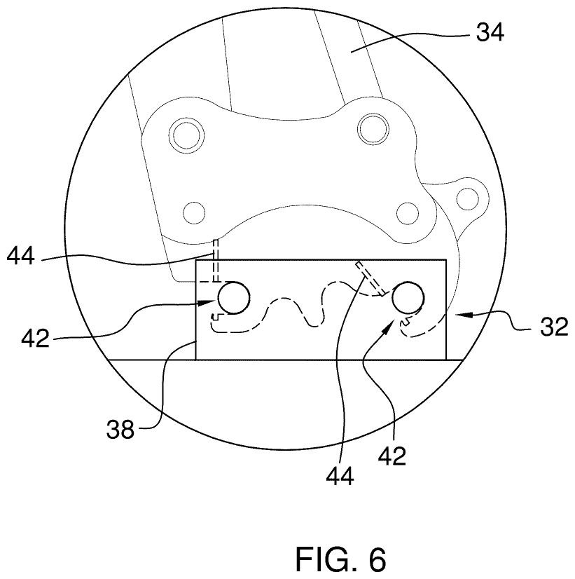

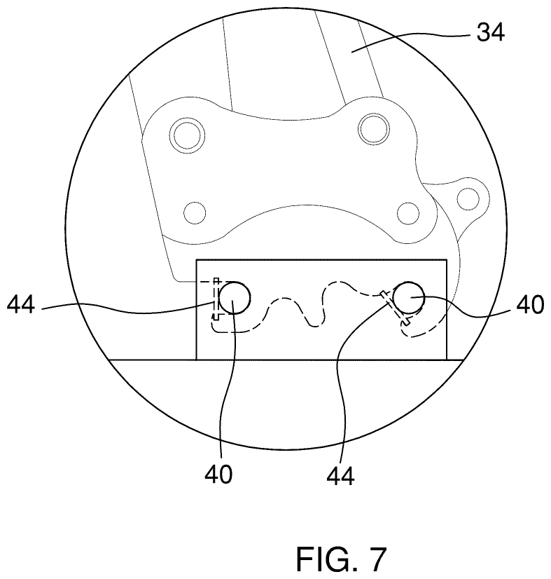

A coupler 32 is coupled to the bracket 12. The coupler 32 is generally configured to releasably attach the bracket 12 to a boom arm 34 of an excavating vehicle 36. For example, a pair of plates 38 may extend upwardly from the upper wall 14. The pair of plates 38 are generally spaced from each other across the upper wall 14. The pair of plates 38 may be perpendicular to the upper wall 14. The pair of plates 38 may be centered between the pair of lateral walls 16 of the bracket 12. A pair of pins 40 may be coupled to and extend between the pair of plates 38. The pair of pins 40 are generally spaced from each other wherein the pair of pins 40 are configured to be positionable within a pair of slots 42 extending into the boom arm 34 of the excavating vehicle 36. The pair of pins 40 may be parallel to the plurality of flanges 24. The boom arm 34 of the excavating vehicle 36 typically includes a pair of clamps 44. Each clamp of the pair of clamps 44 generally slides outward from the boom arm 34 to close off a respective slot of the pair of slots 42. The pair of clamps 44 can therefore secure the pair of pins 40 within the pair of slots 42, as shown in FIGS. 6 and 7.

A spool 46 is rotatably positioned on the rod 30. In some embodiments, the spool 46 may be removably positionable on the rod 30. The spool 46 may have a radius that is less than a distance between the upper wall 14 of the bracket 12 and the pair of apertures 28 to ensure that the spool 46 can rotate beneath the bracket 12. The spool 46 is configured to unwind a cable 48 onto a surface 50 while the spool 46 is rotated on the rod 30. The spool 46 is configured position the cable 48 along the surface 50 while the excavating vehicle 36 is moved adjacent to the surface 50. the spool 46 is configured to be suspended above the surface 50 by the boom arm 34 of the excavation vehicle wherein the spool 46 is configured to be rotated parallel to the surface 50 while the cable 48 is being unwound.

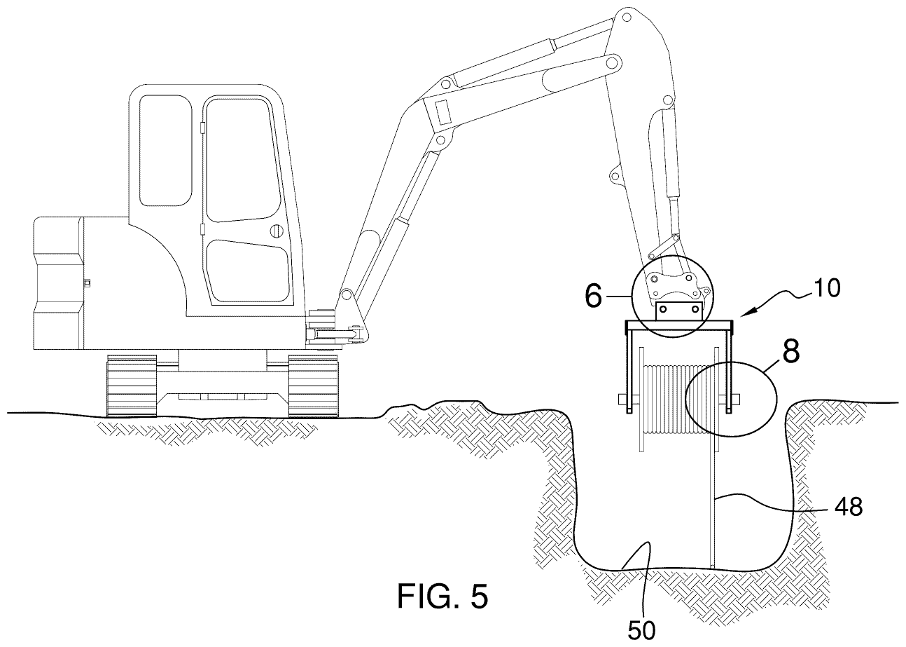

As shown in FIG. 5, the boom arm 34 may suspend the spool 46 over a trench where the cable 48 is being laid. As the excavating vehicle 36 is driven parallel to the trench, the spool 46 rotates on the rod 30 to release the cable 48 onto the surface 50 of the trench. In some more specific examples, a weight of the cable 48 that is draping off the spool 46 onto the surface 50 may rotate the spool 46, or a user may pull on the cable 48 to rotate the spool 46, or a user may push on the spool 46 to rotate the spool 46.

A pair of retainers 52 may be coupled to the rod 30. In embodiments where the rod 30 is removably positionable within the pair of apertures 28, the pair of retainers 52 may be releasably couplable to the rod 30. In such embodiments, each retainer of the pair of retainers 52 may be positionable between a respective opposing end of a pair of opposing ends 56 of the rod 30 and the outer surface 22 of each lateral wall of the pair of lateral walls 16. More generally speaking, the pair of retainers 52 secure a position of the rod 30 within the pair of apertures 28 and inhibit the rod 30 from being removed from the pair of apertures 28.

Accordingly, the pair of retainers 52 may have a diameter exceeding a diameter of the rod 30 and the pair of apertures 28. For example, each retainer of the pair of retainers 52 comprising a cap that is positionable to cover the respective opposing end of the pair of opposing ends 56 of the rod 30. Alternatively, the pair of retainers 52 may each comprise a nut having a threaded hole that is threaded complementarily to a threaded surface extending from each opposing end of the pair of opposing ends 56 of the rod 30 wherein each nut is threadably couplable to the respective opposing end of the rod 30. Washers, clamps, and other alternative embodiments of the pair of retainers 52 are also contemplated.

A pair of panels 54 may be coupled to the bracket 12. Each panel of the pair of panels 54 is generally positioned to cover an intersection between an associated end surface of the pair of end surfaces 18 of the upper wall 14 and a respective lateral wall of the pair of lateral walls 16. By covering the intersection, the pair of panels 54 reinforce a connection between the upper wall 14 and each respective lateral wall of the pair of lateral walls 16. Each panel of the pair of panels 54 may cover an entirety of the associated end surface of the pair of end surfaces 18 of the upper wall 14 of the bracket 12.

In use, the bracket 12 can be releasably coupled to the boom arm 34 of the excavating vehicle 36 by inserting the pair of pins 40 of the coupler 32 into the pair of slots 42 of the boom arm 34. The boom arm 34 can then suspend the cable 48 laying device 10, and particularly the spool 46, over the surface 50 where the cable 48 is being installed. For example, as shown in FIG. 5, the boom arm 34 can suspend the spool 46 over the trench. As the excavation vehicle drives alongside the trench, rotation of the spool 46 on the rod 30 will release the cable 48, such that the cable 48 falls neatly onto the surface 50 of the trench.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cable pay-off assembly comprising:
a bracket;
a pair of apertures extending through the bracket;
a rod being positioned to extend through the pair of apertures;
a coupler being coupled to the bracket wherein the coupler is configured to releasably attach the bracket to a boom arm of an excavating vehicle; and
a spool being rotatably positioned on the rod wherein the spool is configured to unwind a cable onto a surface while the spool is rotated on the rod and wherein the spool is configured position the cable along the surface while the excavating vehicle is moved adjacent to the surface.

2. The cable pay-off assembly of claim 1, the bracket further comprising an upper wall and a pair of lateral walls being coupled to and extending downwardly from a respective end surface of a pair of end surfaces of the upper wall.

3. The cable pay-off assembly of claim 2, the coupler further comprising:
a pair of plates extending upwardly from the upper wall; and
a pair of pins being coupled to and extending between the pair of plates, the pair of pins being spaced from each other wherein the pair of pins are configured to be positionable within a pair of slots extending into the boom arm of the excavating vehicle.

4. The cable pay-off assembly of claim 2, further comprising a pair of panels being coupled to the bracket, each panel of the pair of panels being positioned to cover an intersection between an associated end surface of the pair of end surfaces of the upper wall and a respective lateral wall of the pair of lateral walls wherein the pair of panels reinforce a connection between the upper wall and each lateral wall of the pair of lateral walls.

5. The cable pay-off assembly of claim 2, each lateral wall of the pair of lateral walls further comprising an outer surface being coplanar with the respective end surface of the pair of end surfaces of the upper wall.

6. The cable pay-off assembly of claim 2, each lateral wall of the pair of lateral walls further comprising a terminal end being distally positioned on each lateral wall of the pair of lateral walls relative to the upper wall.

7. The cable pay-off assembly of claim 6, further comprising a plurality of flanges being coupled to the bracket wherein a respective pair of flanges extend from each lateral wall of the pair of lateral walls, the plurality of flanges being positioned to extend outwardly from the terminal end of each lateral wall of the pair of lateral walls.

8. The cable pay-off assembly of claim 1, wherein the pair of apertures are aligned with each other.

9. The cable pay-off assembly of claim 1, wherein the rod has a diameter being complementary to a diameter of each aperture of the pair of apertures wherein friction between the rod and the pair of lateral walls inhibits the rod from rotating within the pair of apertures.

10. A cable pay-off assembly comprising:
a bracket having an upper wall and a pair of lateral walls being coupled to and extending downwardly from a respective end surface of a pair of end surfaces of the upper wall, each lateral wall of the pair of lateral walls being perpendicular to the upper wall, each lateral wall of the pair of lateral walls having a terminal end being distally positioned on each lateral wall of the pair of lateral walls relative to the upper wall, each lateral wall of the pair of lateral walls having an outer surface being coplanar with the respective end surface of the pair of end surfaces of the upper wall;
a pair of apertures extending through the bracket, each aperture of the pair of apertures being positioned on a respective lateral wall of the pair of lateral walls, each aperture of the pair of apertures being positioned proximate to the terminal end of the respective lateral wall of the pair of lateral walls, the pair of apertures being aligned with each other;
a rod being positionable to extend through the pair of apertures, the rod being parallel to the upper wall of the bracket while the rod is positioned within the pair of apertures, the rod having a length exceeding a length of the upper wall wherein the rod extends outwardly from each lateral wall of the pair of lateral walls while the rod is positioned within the pair of apertures, the rod having a diameter being complementary to a diameter of each aperture of the pair of apertures wherein friction between the rod and the pair of lateral walls inhibits the rod from rotating within the pair of apertures;
a coupler being coupled to the bracket wherein the coupler is configured to releasably attach the bracket to a boom arm of an excavating vehicle, the coupler including:
a pair of plates extending upwardly from the upper wall of the bracket, the pair of plates being spaced from each other across the upper wall, the pair of plates being perpendicular to the upper wall, the pair of plates being centered between the pair of lateral walls of the bracket; and
a pair of pins being coupled to and extending between the pair of plates, the pair of pins being spaced from each other wherein the pair of pins are configured to be positionable within a pair of slots extending into the boom arm of the excavating vehicle, the pair of pins being parallel to the plurality of flanges;
a spool being rotatably positionable on the rod wherein the spool is configured to unwind a cable onto a surface while the spool is rotated on the rod and wherein the spool is configured position the cable along the surface while the excavating vehicle is moved adjacent to the surface, the spool being configured to be suspended above the surface by the boom arm of the excavation vehicle wherein the spool is configured to be rotated parallel to the surface while the cable is being unwound;
a pair of retainers being releasably couplable to the rod wherein each retainer of the pair of retainers is positionable between a respective opposing end of a pair of opposing ends 56 of the rod and the outer surface of each lateral wall of the pair of lateral walls wherein the pair of retainers secure a position of the rod within the pair of apertures, the pair of retainers having a diameter exceeding a diameter of the rod and the pair of apertures wherein the pair of retainers inhibit the rod from being removed from the pair of apertures while the pair of retainers are coupled to the rod;
a pair of panels being coupled to the bracket, each panel of the pair of panels being positioned to cover an intersection between an associated end surface of the pair of end surfaces of the upper wall and a respective lateral wall of the pair of lateral walls wherein the pair of panels reinforce a connection between the upper wall and each lateral wall of the pair of lateral walls, the panel covering an entirety of the associated end surface of the pair of end surfaces of the upper wall of the bracket; and
a plurality of flanges being coupled to the bracket wherein a respective pair of flanges extend from each lateral wall of the pair of lateral walls, the plurality of flanges being positioned to extend outwardly from the terminal end of each lateral wall of the pair of lateral walls, the respective pair of flanges of the plurality of flanges being perpendicular to the terminal end of each lateral wall of the pair of lateral walls, each flange of the respective pair of flanges of the plurality of flanges having an exterior surface being coplanar with the outer surface of each lateral wall of the pair of lateral walls.
